(19) United States
(12) Patent Application Publication
(10) Pub. No.: US 2022/0327918 A1
(43) Pub. Date: Oct. 13, 2022

(54) DEVICE AND METHOD FOR PREDICTING TRAFFIC INFORMATION

(71) Applicants: Hyundai Motor Company, Seoul (KR); Kia Corporation, Seoul (KR)

(72) Inventor: Nam Hyuk Kim, Seoul (KR)

(21) Appl. No.: 17/397,391

(22) Filed: Aug. 9, 2021

(30) Foreign Application Priority Data
Apr. 5, 2021 (KR) 10-2021-0044210

(51) Int. Cl. G08G 1/01

(52) U.S. Cl. CPC G08G 1/0112; G08G 1/0125

(57) ABSTRACT

A device and a method for predicting traffic information are provided to improve a traffic information prediction accuracy. The device includes a storage that stores a plurality of probe data generation models based on characteristic of a road and a communication device that receives probe data from a probe vehicle traveling on a target road. A controller detects a probe data generation model corresponding to a characteristic of the target road among the plurality of probe data generation models, generates a preset number of probe data based on the detected probe data generation model, and predicts traffic information of the target road based on the generated probe data and the received probe data.

### CROSS-REFERENCE TO RELATED APPLICATION

This application claims the benefit of priority to Korean Patent Application No. 10-2021-0044210, filed in the Korean Intellectual Property Office on Apr. 5, 2021, the entire contents of which are incorporated herein by reference.

### TECHNICAL FIELD

The present disclosure relates to a technology for predicting information on traffic on a road based on a learning model that generates probe data

### BACKGROUND

In general, a navigation system provides a user with real-time traffic information of a specific area or an optimal route to a destination using the real-time traffic information in response to a request of the user. In this connection, the real-time traffic information refers to traffic information at a time point at which the traffic information request of the user is generated.

Since such traffic information changes from time to time, when the user travels along the optimal route using the real-time traffic information and reaches a certain point, real-time traffic information at that point is different from the real-time traffic information at the time point at which the traffic information request is generated. Therefore, effectiveness of the traffic information initially provided to the user is inferior. To prevent this, a method for predicting traffic information at the certain point at a time point at which the user is expected to reach the certain point using past traffic information and the real-time traffic information has been proposed.

In this connection, the real-time traffic information (e.g., ETA: Expected Time Arrival) is predicted based on probe data (e.g., GPS data) received from a probe vehicle traveling on a road. In this connection, to predict accurate traffic information (e.g., a time it takes to transit the road), the number of probe vehicles transited the road (or a reference section of the road) during a reference time (e.g., 5 minutes) must exceed a reference value (e.g., 30), but the number of probe vehicles is limited. Eventually, the conventional traffic information prediction technology predicts the traffic information of the road using less than a reference number (e.g., 30) of probe data, and thus an accuracy is significantly deteriorated.

The matters described in this background are written to enhance an understanding of the background of the invention, which may include matters other than the prior art already known to those of ordinary skill in the field to which this technology belongs.

### SUMMARY

The present disclosure has been made to solve the above-mentioned problems occurring in the prior art while advantages achieved by the prior art are maintained intact. An aspect of the present disclosure provides a device and a method for predicting traffic information that have a plurality of probe data generation models that have completed learning for each characteristic of a road, detect a probe data generation model corresponding to a characteristic of a target road among the plurality of probe data generation models, generate predetermined probe data based on the detected probe data generation model, and predict traffic information of the target road based on the generated predetermined probe data and probe data received from a probe vehicle traveling on the target road, thereby improving a traffic information prediction accuracy.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for predicting traffic information may include a storage for storing a plurality of probe data generation models based on characteristic of a road, a communication device configured to receive probe data from a probe vehicle traveling on a target road, and a controller configured to detect a probe data generation model corresponding to a characteristic of the target road among the plurality of probe data generation models, generate a preset number of probe data based on the detected probe data generation model, and predict traffic information of the target road based on the generated probe data and the received probe data.

In one implementation, the probe data may be a road transit time. The controller may be configured to generate a preset number of road transit times based on the detected probe data generation model, and calculate a transit time of the target road based on the generated road transit times and a road transit time received from the probe vehicle. In addition, the controller may be configured to calculate an average of the generated road transit times and the received road transit time as the transit time of the target road.

The characteristic of the road may include at least one of the number of probe vehicles, a type of the road, the number of lines, a length of the road, and/or a shape of the road. In one implementation, the controller may be configured to calculate a similarity with each characteristic of the road based on the characteristic of the target road, and detect a probe data generation model corresponding to a characteristic of the road with the highest similarity as a probe data generation model of the target road. The controller may be configured to detect a probe data generation model having the number of probe vehicles having a smallest difference from the number of probe vehicles of the target road as the characteristic of the road as the probe data generation model of the target road when the probe data generation model of the target road is not detected based on the calculated similarity.

According to another aspect of the present disclosure, a method for predicting traffic information may include storing, by storage, a plurality of probe data generation models based on characteristic of a road, receiving, by a communication device, probe data from a probe vehicle traveling on a target road, detecting, by a controller, a probe data generation model corresponding to a characteristic of the target road among the plurality of probe data generation models, and generating, by the controller, a preset number of probe data based on the detected probe data generation model, and predicting traffic information of the target road based on the generated probe data and the received probe data.

In one implementation, the predicting of the traffic information of the target road may include generating a preset number of road transit times based on the detected probe data generation model, and calculating a transit time of the target road based on the generated road transit times and a road transit time received from the probe vehicle. The calculating of the transit time of the target road may include calculating an average of the generated road transit times and the received road transit time as the transit time of the target road.

In addition, the detecting of the probe data generation model corresponding to the characteristic of the target road may include calculating a similarity with each characteristic of the road based on the characteristic of the target road, and detecting a probe data generation model corresponding to a characteristic of the road with the highest similarity as a probe data generation model of the target road. The detecting of the probe data generation model corresponding to the characteristic of the target road may further include detecting a probe data generation model having the number of probe vehicles having a smallest difference from the number of probe vehicles of the target road as the characteristic of the road as the probe data generation model of the target road when the probe data generation model of the target road is not detected based on the calculated similarity.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram of a traffic information prediction device according to an embodiment of the present disclosure;

FIG. 2 is an exemplary view showing a structure of a probe data generation model used in a traffic information prediction device according to an embodiment of the present disclosure;

FIG. 3 is an exemplary view showing an operation of a generator in a probe data generation model used for a traffic information prediction device according to an embodiment of the present disclosure;

FIG. 4 is an exemplary view showing an operation of a discriminator in a probe data generation model used for a traffic information prediction device according to an embodiment of the present disclosure; and

FIG. 5 is a flowchart of an embodiment of a traffic information prediction method according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

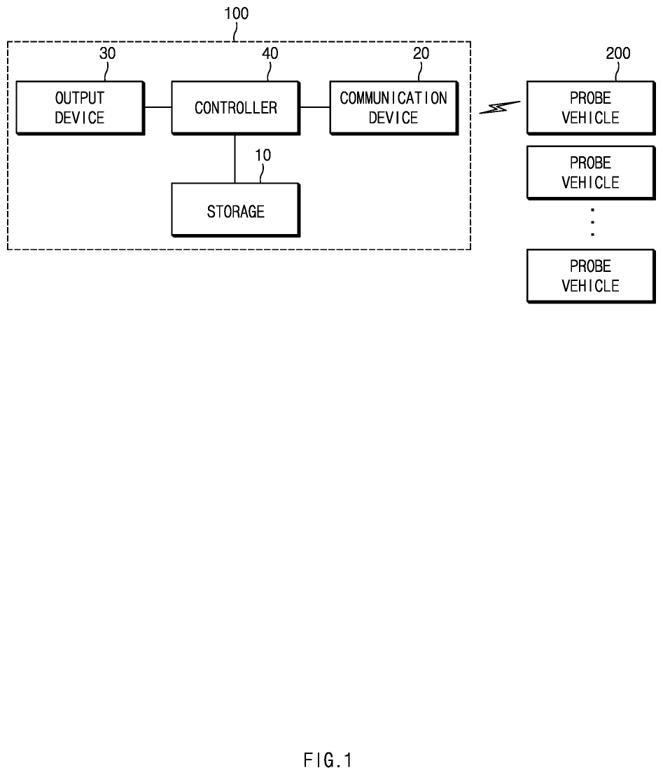

FIG. 1 is a block diagram of a traffic information prediction device according to an embodiment of the present disclosure. As shown in FIG. 1, a traffic information prediction device 100 according to an embodiment of the present disclosure may include storage 10, a communication device 20, an output device 30, and a controller 40. In this connection, depending on a method for implementing the traffic information prediction device 100 according to an embodiment of the present disclosure, components may be combined with each other to be implemented as one component, and some components may be omitted.

Each of the components will be described. First, the storage 10 may be configured to store a plurality of probe data generation models that have completed learning for each characteristic of a road. In this connection, the probe data generation model, which is a model that generates a fake road transit time based on a real road transit time (a time it takes to transit the road) of a probe vehicle 200 and a latent vector “z”, may be, for example, implemented with a conditional generative adversarial network (CGAN) that has completed learning. In this connection, the CGAN may be configured to perform learning for generating a transit time for each road based on an intention of a designer, or more specifically, perform learning for generating a transit time for each section of each road.

The storage 10 may be configured to store various logic, algorithms, and programs required in a process of detecting a probe data generation model corresponding to a characteristic of a target road among the plurality of probe data generation models, generating predetermined probe data (a preset number of probe data) based on the detected probe data generation model, and predicting traffic information of the target road (e.g., a time it takes to traverse the target road or a time it takes to transit a reference section of the target road) based on the generated predetermined probe data and probe data (e.g., GPS data) received from the probe vehicle 200 traveling on the target road. In this connection, the GPS data includes time data as well as coordinate data

The storage 10 may include at least one type of recording media (storage media) of a memory of a flash memory type, a hard disk type, a micro type, a card type (e.g., a secure digital card (SD card) or an eXtream digital card (XD card)), and the like, and a memory of a random access memory (RAM), a static RAM (SRAM), a read-only memory (ROM), a programmable ROM (PROM), an electrically erasable PROM (EEPROM), a magnetic RAM (MRAM), a magnetic disk, and an optical disk type.

The communication device 20, which is a module that provides a communication interface with the probe vehicle 200 traveling on the road, may be configured to periodically receive the probe data from the probe vehicle 200. In this connection, the probe vehicle 200 may have a telematics terminal as a vehicle terminal. The communication device 20 may include at least one of a mobile communication module, a wireless Internet module, and/or a short-range communication module to communicate with the probe vehicle 200.

The mobile communication module may be configured to communicate with the probe vehicle 200 through a mobile communication network built based on technical standards or communication schemes for mobile communication (e.g., a global system for mobile communication (GSM), a code division multi access (CDMA), a code division multi access 2000 (CDMA 2000), an enhanced voice-data optimized or enhanced voice-data only (EV-DO)), a wideband CDMA (WCDMA), a high speed downlink packet access (HSDPA), a high speed uplink packet access (HSUPA), a long term evolution (LTE), a long term evolution-advanced (LTEA), and the like), 4th generation mobile telecommunication (4G), and 5th generation mobile telecommunication (5G).

The wireless Internet module, which is a module for wireless Internet access, may be configured to communicate with the probe vehicle 200 via a wireless LAN (WLAN), a wireless-fidelity (Wi-Fi), a wireless fidelity (Wi-Fi) Direct, a digital living network alliance (DLNA), a wireless broadband (WiBro), a world interoperability for microwave access (WiMAX), a high speed downlink packet access (HSDPA), a high speed uplink packet access (HSUPA), a long term evolution (LTE), a long term evolution-advanced (LTE-A), and the like. The short-range communication module may support short-range communication using at least one of technologies of a Bluetooth™, a radio frequency identification (RFID), an infrared data association (IrDA), an ultra wideband (UWB), a ZigBee, a near field communication (NFC), and a wireless universal serial bus (Wireless USB).

The output device 30 may, for example, provides the time required to transit the target road or the time required to transit the reference section of the target road, which is the traffic information of the target road predicted by the controller 40, to a user. The controller 40 may be configured to perform overall control such that each of the components can normally perform a function thereof. The controller 40 may be implemented in a form of hardware, software, or a combination of the hardware and the software. Preferably, the controller 40 may be implemented as a microprocessor, but may not be limited thereto.

In particular, the controller 40 may include the plurality of probe data generation models that have completed the learning for each characteristic of the road, and perform various control in the process of detecting the probe data generation model corresponding to the characteristic of the target road among the plurality of probe data generation models, generating the predetermined probe data based on the detected probe data generation model, and predicting the traffic information of the target road based on the generated predetermined probe data and the probe data received from the probe vehicle 200 traveling on the target road. In this connection, the characteristics of the road may include the number of probe vehicles 200, a type of the road, the number of lines, a length of the road, a shape of the road, and the like.

As an example, the controller 40 may be configured to generate a preset number of road transit times (times it take to transit the road) based on the detected probe data generation model, and calculate the target road transit time based on the generated transit times and a road transit time received from the probe vehicle 200 traveling on the target road. In this connection, the controller 40 may be configured to calculate an average of the road transit times generated based on the probe data generation model and the road transit time received from the probe vehicle 200 as the transit time of the target road.

Since the controller 40 may periodically receive the GPS data (including the time data) from the probe vehicle 200 via the communication device 20, a location of the probe vehicle 200 may be identified in real time. Therefore, the controller 40 may be configured to identify an entry time point of the target road or the reference section of the target road of the probe vehicle 200, and calculate the time required to transit the target road (a time required) or the time required to transit the reference section of the target road (a time required) as the traffic information based on the entry time point and the calculated target road transit time. The controller 40 may be configured to identify the location of the probe vehicle 200 in real time in association with a navigation system (not shown). In other words, the controller 40 may be configured to detect the location of the probe vehicle 200 on the road based on the GPS data received from the probe vehicle 200.

The controller 40 may use a generally well-known similarity calculation algorithm in the process of detecting the probe data generation model corresponding to the characteristic of the target road among the plurality of probe data generation models corresponding to the characteristics of the road. In other words, the controller 40 may be configured to calculate a similarity with each characteristic of the road based on the characteristic of the target road, and detect a probe data generation model corresponding to a characteristic of the road with the highest similarity as the probe data generation model of the target road. In this connection, when there is no probe data generation model having the similarity exceeding a reference value, the controller 40 may be configured to determine a probe data generation model with the number of probe vehicles 200 that is most similar to the number of probe vehicles 200 of the target road (the number of probe data received from the probe vehicle 200) as the characteristic of the road as the probe data generation model of the target road.

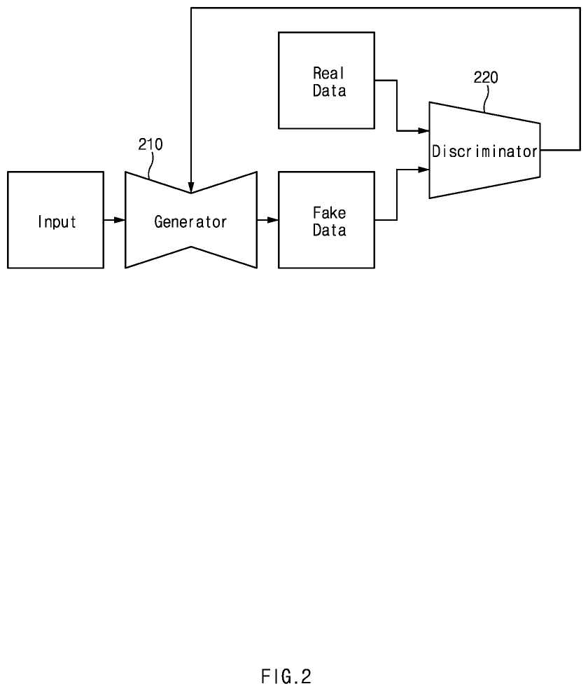

Hereinafter, a structure of the probe data generation model and a process in which the controller 40 trains the probe data generation model will be described with reference to FIGS. 2 to 4. FIG. 2 is an exemplary view showing a structure of a probe data generation model used in a traffic information prediction device according to an embodiment of the present disclosure.

As shown in FIG. 2, the probe data generation model used for the traffic information prediction device according to an embodiment of the present disclosure may be implemented with the conditional generative adversarial network (CGAN), for example. Such CGAN may include a generator 210 and a discriminator 220. In this connection, to make it difficult for the discriminator 220 to determine whether the probe data is real probe data or fake probe data, the generator 210 that tries to generate the fake probe data that is as real as possible, and the discriminator 220 that tries to discriminate between the real probe data and the fake probe data with a high accuracy learn in a manner of being hostile to each other.

The controller 40 may be configured to repeatedly perform hostile learning which is a process of first training the discriminator 220 and then training the generator 210 by reflecting a learning result of the discriminator 220. The training of the discriminator 220 is composed of two major processes. A first process is a process of inputting the real probe data into the discriminator 220 and training the discriminator 220 to discriminate the real probe data to be real. A second process is a process of inputting the fake probe data generated by the generator 210 and training the discriminator 220 to discriminate the fake probe data to be fake. Through such process, the discriminator 220 may be configured to discriminate the real probe data to be real and the fake probe data to be fake. After training the discriminator 220 as such, it is necessary to train the generator 210 in a direction of deceiving the trained discriminator 220. In other words, the controller 40 may be configured to train the generator 210 to generate the fake probe data similar to the real probe data enough to be determined, by the discriminator 220, to be real.

When such training process is repeated, the discriminator 220 and the generator 210 recognize each other as hostile competitors and both develop. As a result, the generator 210 may be configured to generate the fake probe data that is completely similar to the real probe data. Accordingly, the discriminator 220 is not able to discriminate between the real probe data and the fake probe data. In other words, the generator 210 and the discriminator 220 compete each other in a manner in which the generator 210 tries to lower a discrimination success probability of the discriminator 220, and the discriminator 220 tries to increase the discrimination success probability, so that the generator 210 and the discriminator 220 develop each other.

More specifically, the CGAN is trained in a scheme of solving a ‘minmax problem’ as shown in Equation 1 below using an objective function V(D,G).

$${min}_{G} {max}_{D} V ( D , G ) = \text{?} [ log D ( x \vert y ) ] + \text{?} [ log ( 1 - D ( G ( z \vert y ) ) ) ] \qquad Equation 1$$

$$\text{?} \text{indicates text missing or illegible when filed}$$

In this connection, x˜p_{data}(x) means data sampled from a probability distribution for the real probe data, z˜p_{z}(z) generally means data sampled from random noise using a Gaussian distribution, and “z” means the latent vector (a vector in a latent space). D(x|y) is the discriminator 220, and is 1 when the probe data is real, and 0 when the probe data is fake. D(G(z|y)) is 1 when the probe data generated by the generator 210 is determined to be real, and 0 when the probe data is discriminated to be fake.

First of all, in terms of maximizing V(D, G) by D, which is the discriminator 220, to maximize Equation 1, both first and second terms on a right side must be maximum, so that log D(xy) and log(1−D(G(z|y))) both should be maximum. Therefore, D(x|y) should be 1, which means training D to classify the real probe data as real. Similarly, because 1−D(G(z|y)) should be 1, D(G(z|y)) should be 0, which means training the discriminator 220 to discriminate the fake probe data generated by the generator 210 as fake. In the end, the training of D that allows V(D,G) to become maximum is the process in which the discriminator 220 is trained to discriminate the real probe data to be real and the fake probe data to be fake.

Next, in terms of minimizing V(D,G) by G, which is the generator 210, since G is not included in the first term on the right side of Equation 1, the first term may be omitted since not being related to the generator 210. To minimize the second term, log(1−D(G(z|y))) must be minimized. Therefore, log(1−D(G(z|y))) should be 0 and D(G(z|y)) should be 1. This means training the generator 210 to generate the fake probe data that is perfect enough to be discriminated to be real by the discriminator 220. Accordingly, the training of the discriminator 220 in the direction of maximizing V(D,G) and training the generator 210 in the direction of minimizing V(D,G) is called the ‘minmax problem’.

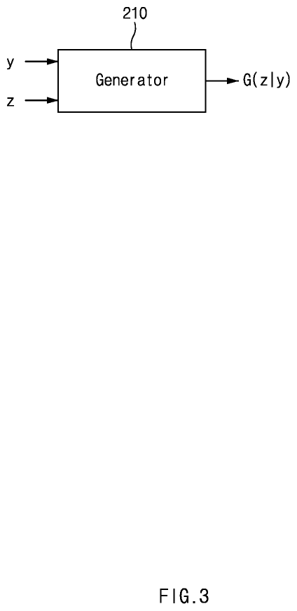

FIG. 3 is an exemplary view showing an operation of a generator in a probe data generation model used for a traffic information prediction device according to an embodiment of the present disclosure. As shown in FIG. 3, the generator 210 in the probe data generation model used for the traffic information prediction device according to an embodiment of the present disclosure may be configured to receive real probe data “y” and the latent vector “z” from the probe vehicle 200, and generate fake probe data G(z|y) following a distribution of the real probe data “y”. In this connection, the generator 210 may be configured to generate a plurality of fake probe data (G(z|y)).

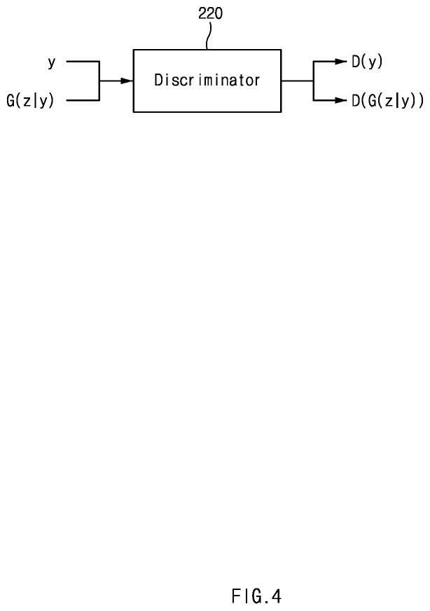

FIG. 4 is an exemplary view showing an operation of a discriminator in a probe data generation model used for a traffic information prediction device according to an embodiment of the present disclosure. As shown in FIG. 4, the discriminator 220 in the probe data generation model used for the traffic information prediction device according to an embodiment of the present disclosure may be configured to receive the real probe data “y” from the probe vehicle 200 and the fake probe data G(z|y) generated by the generator 210, determine the real probe data “y” to be real (D(y)), and determine the fake probe data G(z|) to be fake (D(G(z|y))).

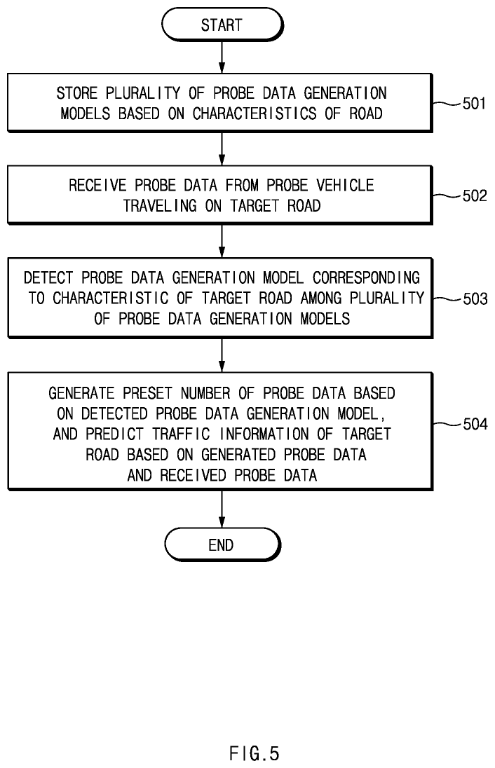

FIG. 5 is a flowchart of an embodiment of a traffic information prediction method according to an embodiment of the present disclosure. First, the storage 10 may be configured to store the plurality of probe data generation models based on the characteristics of the road (501). Thereafter, the communication device 20 may be configured to receive the probe data from the probe vehicle traveling on the target road (502).

Thereafter, the controller 40 may be configured to detect the probe data generation model corresponding to the characteristic of the target road among the plurality of probe data generation models (503). Thereafter, the controller 40 may be configured to generate a preset number of probe data based on the detected probe data generation model, and predict the traffic information of the target road based on the generated probe data and the received probe data (504). In this connection, the controller 40 may be configured to predict the time required to transit the target road as the traffic information of the target road.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

The device and the method for predicting the traffic information according to an embodiment of the present disclosure as described above may have the plurality of probe data generation models that have completed the learning for each characteristic of the road, detect the probe data generation model corresponding to the characteristic of the target road among the plurality of probe data generation models, generate the predetermined probe data based on the detected probe data generation model, and predict the traffic information of the target road based on the generated predetermined probe data and the probe data received from the probe vehicle traveling on the target road, thereby improving the traffic information prediction accuracy.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for predicting traffic information, comprising:
storage configured to store a plurality of probe data generation models based on characteristic of a road;
a communication device configured to receive probe data from a probe vehicle traveling on a target road; and
a controller configured to:
detect a probe data generation model corresponding to a characteristic of the target road among the plurality of probe data generation models;
generate a preset number of probe data based on the detected probe data generation model; and
predict traffic information of the target road based on the generated probe data and the received probe data.

2. The device of claim 1, wherein the probe data is a road transit time.

3. The device of claim 2, wherein the controller is configured to:
generate a preset number of road transit times based on the detected probe data generation model; and
calculate a transit time of the target road based on the generated road transit times and a road transit time received from the probe vehicle.

4. The device of claim 3, wherein the controller is configured to calculate an average of the generated road transit times and the received road transit time as the transit time of the target road.

5. The device of claim 1, wherein the characteristic of the road includes at least one of the number of probe vehicles, a type of the road, the number of lines, a length of the road, and a shape of the road.

6. The device of claim 5, wherein the controller is configured to:
calculate a similarity with each characteristic of the road based on the characteristic of the target road; and
detect a probe data generation model corresponding to a characteristic of the road with the highest similarity as a probe data generation model of the target road.

7. The device of claim 6, wherein the controller is configured to detect a probe data generation model having the number of probe vehicles having a smallest difference from the number of probe vehicles of the target road as the characteristic of the road as the probe data generation model of the target road when the probe data generation model of the target road is not detected based on the calculated similarity.

8. A method for predicting traffic information, comprising:
storing, by a storage, a plurality of probe data generation models based on characteristic of a road;
receiving, by a communication device, probe data from a probe vehicle traveling on a target road;
detecting, by a controller, a probe data generation model corresponding to a characteristic of the target road among the plurality of probe data generation models; and
generating, by the controller, a preset number of probe data based on the detected probe data generation model, and predicting traffic information of the target road based on the generated probe data and the received probe data.

9. The method of claim 8, wherein the probe data is a road transit time.

10. The method of claim 9, wherein the predicting of the traffic information of the target road includes:
generating a preset number of road transit times based on the detected probe data generation model; and
calculating a transit time of the target road based on the generated road transit times and a road transit time received from the probe vehicle.

11. The method of claim 10, wherein the calculating of the transit time of the target road includes:
calculating an average of the generated road transit times and the received road transit time as the transit time of the target road.

12. The method of claim 8, wherein the characteristic of the road include at least one of the number of probe vehicles, a type of the road, the number of lines, a length of the road, and a shape of the road.

13. The method of claim 12, wherein the detecting of the probe data generation model corresponding to the characteristic of the target road includes:
calculating a similarity with each characteristic of the road based on the characteristic of the target road; and
detecting a probe data generation model corresponding to a characteristic of the road with the highest similarity as a probe data generation model of the target road.

14. The method of claim 13, wherein the detecting of the probe data generation model corresponding to the characteristic of the target road further includes:
detecting a probe data generation model having the number of probe vehicles having a smallest difference from the number of probe vehicles of the target road as the characteristic of the road as the probe data generation model of the target road when the probe data generation model of the target road is not detected based on the calculated similarity.
